(19) United States
(12) Patent Application Publication
(10) Pub. No.: US 2012/0079088 A1
(43) Pub. Date: Mar. 29, 2012

(54) PROVING DOMAIN NAME OWNERSHIP

(75) Inventor: David J. Nicholson, Seattle, WA (US)

(73) Assignee: MICROSOFT CORPORATION, Redmond, WA (US)

(21) Appl. No.: 12/891,696

(22) Filed: Sep. 27, 2010

(51) Int. Cl. G06F 15/173

(52) U.S. Cl. 709/223

(57) ABSTRACT

Verification that a customer has ownership over a particular domain name. A computing system receives a request to provide a network service to a customer for action upon a particular domain name. In response, the computing system provides information to the customer over a network, and instructs the customer to edit a domain name record for the particular domain name using the provided information. For instance, the customer might be provided with a Globally-Unique IDentifier (GUID), and instruct the customer to insert the GUID into a particular record associated with the domain name in the DNS system. Upon verifying that the domain name record has indeed been edited using the provided information, the customer is confirmed as being an owner of the domain name.

### BACKGROUND

A wide variety of services are now offered over the Internet. A domain name is an identification label that defines a realm of administrative authority on the Internet, and is based on the Domain Name System (DNS), a distributed hierarchical naming and permissions model for identifying resources available on the Internet. The root domain is “.” and top-level domains are connected to this root domain. There are hundreds of such top-level domains, but some common examples include “com.”, “edu.”, “gov.”, “uk.”, and so forth. The legal entity that has authority over “edu.” may form an agreement with an entity (fictionally called herein “Contoso Inc.”) to allow Contoso Inc. to control the “contoso.edu.” portion of the domain name system.

Recursively, Contoso Inc. may choose to delegate control over further sub portions of the DNS tree. For example, Contoso Inc. may delegate control over the domain name “chemistry.contoso.edu.” to the Chemistry department at Contoso Inc. If the owner of a domain does not delegate control over a particular subdomain, then the owner of the domain may be assumed to control that subdomain by default.

Some services performed on behalf of a customer are really only suitable if the customer were in fact an owner of a particular domain name. Accordingly, before providing such services on behalf of the customer, a prudent service provider will first obtain some security that the customer is indeed the owner of the particular domain name.

In one conventional method for verifying domain name ownership, the user is asked to register a new domain, which is a subdomain of the domain they are attempting to prove ownership of. Domain name ownership is then verified by embedding a token in the subdomain name. There is, however, a list of domain names for which this validation will not work, especially for those domain names that are top-level domain names, or high level domain names.

### BRIEF SUMMARY

At least one embodiment described herein relates to the computer-implemented verification that a customer has ownership over a particular domain name. The computing system receives a request to provide a network service to a customer for action upon a particular domain name. For instance, the network service might be something that should not be performed unless there is at least some assurance that the customer has ownership of the domain name.

The computing system provides information to the customer over a network, and instructs the customer to edit a domain name record for the particular domain name using the provided information. For instance, the customer might be provided with a Globally-Unique IDentifier (GUID), and instructed to insert the GUID into a particular record associated with the domain name in the DNS system. Upon verifying that the domain name record has indeed been edited using the provided information, the customer is confirmed as being an owner of the domain name. In some embodiments, a time-to-live is enforced against the edited domain name record, in which case perhaps ownership is no longer assumed after the time-to-live has expired.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates an example domain name system (DNS) tree;

FIG. 3 illustrates a flowchart of a method for a computing system to verify ownership of a particular domain name; and

FIG. 4 illustrates a flowchart of a method for verifying that the domain name record has been edited using the information provided by the service.

### DETAILED DESCRIPTION

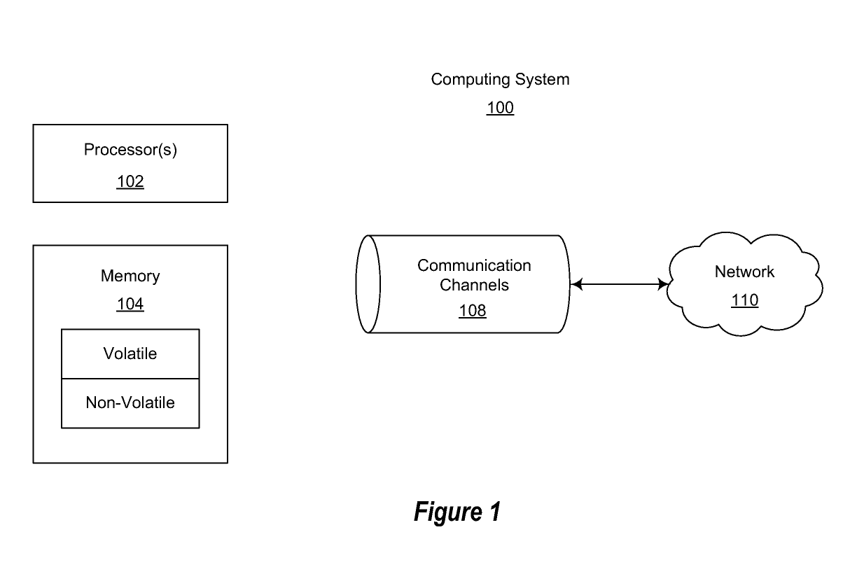

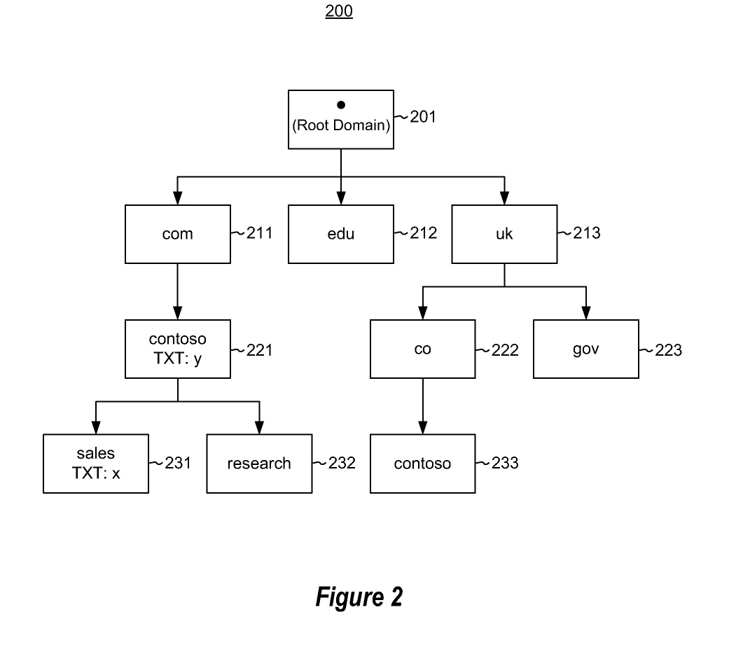

In accordance with embodiments described herein, a domain name ownership verification process is provided. A computing system receives a request to provide a network service to a customer for action upon a particular domain name. In response, the computing system provides information to the customer over a network, and instructs the customer to edit a domain name record for the particular domain name using the provided information. Upon verifying that the domain name record has indeed been edited using the provided information, the customer is confirmed as being an owner of the domain name. First, some introductory discussion regarding computing systems will be described with respect to FIG. 1. Then, the embodiments of the domain name verification will be described with respect to FIGS. 2 through 4.

First, introductory discussion regarding computing systems is described with respect to FIG. 1. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems. As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates an example domain name system (DNS) tree 200. Some of the nodes in the tree 200 represents actual nodes in the existing global DNS tree and thus together represent a sub-set of the global DNS tree. For instance, nodes 201, 211, 212, 213, 222 and 223 represent existing nodes in the existing global DNS tree in the relationship in which they actually exist. While the global DNS tree has existed since the beginning of the Internet, the structure of the DNS tree 200 will now be described as it will be frequently referred to in the subsequent descriptions.

Root domain 201 is referred to using the text “.” and represents the root domain of the global DNS tree. The root domain includes three child domains, the “com” domain 211, the “edu” domain 212, and the “uk” domain 213. Only a subset of the global DNS tree is illustrated as the DNS root domain 201 has a large number of child domains. In the DNS tree 200, permissions may be given from a parent domain to a child domain. The “com” domain 211 is typically used for commercial applications. The “edu” domain 212 is typically used for educational institutions. The “uk” domain 213 is typically used for entities within the United Kingdom.

The DNS tree may also be used for addressing a particular domain. Addressing occurs by using a text string that begins with the text of the domain being addressed and continuing up the ancestral chain until the root domain “.” is encountered, and with each domain text being separated by a period “.” For instance, domain 211 may be addressed using the text “com.”, domain 212 may be addressed using the text “edu.”, and domain 213 may be addressed using the text “uk.”. In common convention, the final period “.” is not expressed, but is simply inferred. Thus, domains 211, 212 and 213 may also be addressed using the simple text “com”, “edu” and “uk”, respectively. As another example specified below, “sales.contoso.com.” may instead be expressed as “sales.contoso.com” with no concluding period. Domains 222 and 223 (corresponding to text “co” and “gov”) and are children of the “uk” domain 213. Thus, the “co” domain 222 and the “gov” domain 223 derive their permissions from the “uk” domain 213. The “co” domain 222 is addressed using the text “co.uk.” (or simply “co.uk”). The “gov” domain 223 is addressed using the text “gov.uk.” (or simply “gov.uk”). Any node (e.g. foo.com.) in the DNS tree can have an “NS” Resource Record (RR). This NS record itself contains a domain name string (e.g. bar.com.), corresponding to a domain name that has an “A” Resource Record. This “A” record contains the IP address (e.g. 1.2.3.4) of a computer that has authority over this domain and all of its sub-domains. When computer 1.2.3.4 receives a DNS query for foo.com. or any sub-domain thereof (e.g. sub.foo.com.) it may provide any answer of its choosing, or can present an NS record to delegate control of the domain to another computer. The root node is a special case, the NS records for the root node are globally and politically agreed upon, and are hard-coded into all DNS software.

The global DNS tree is extensible with new domain names being grafted into the global DNS tree each day. For instance, suppose that at some point, the fictional company, Contoso, Inc., decides to have a domain. They may thus contract with the “com” domain 211 to formulate a child domain 221 called “contoso” for purposes of deriving permissions in furtherance of their United States commercial operations. The new “contoso” domain 221 may be addressed using the text “contoso.com.” or “contoso.com”. Suppose further that Contoso, Inc. wants a domain for furtherance of their United Kingdom commercial operations. In that case, Contoso, Inc., might also contract with the “co” domain 222 to form a child domain 233 also called “contoso” for purposes of deriving permissions in further of the United Kingdom operations. The new “contoso” domain 233 may be addressed using the text “contoso.co.uk.” or “contoso.co.uk”.

Now suppose Contoso, Inc. wants to give its sales department in the United States a particular domain and its research department in the United States their own domains, and grant permissions to those domains. Contoso, Inc., the owner of the “contoso” domain 221, may create a “sales” domain 231 and a “research” domain 232 as children domains from the “contoso” domain 221, and grant permissions to those domains. The new “sales” domain 231 would be addressed using the text “sales.contoso.com.” (or “sales.contoso.com”). The new “research” domain 232 would be addressed using the text “research.contoso.com.” (or “research.contoso.com”).

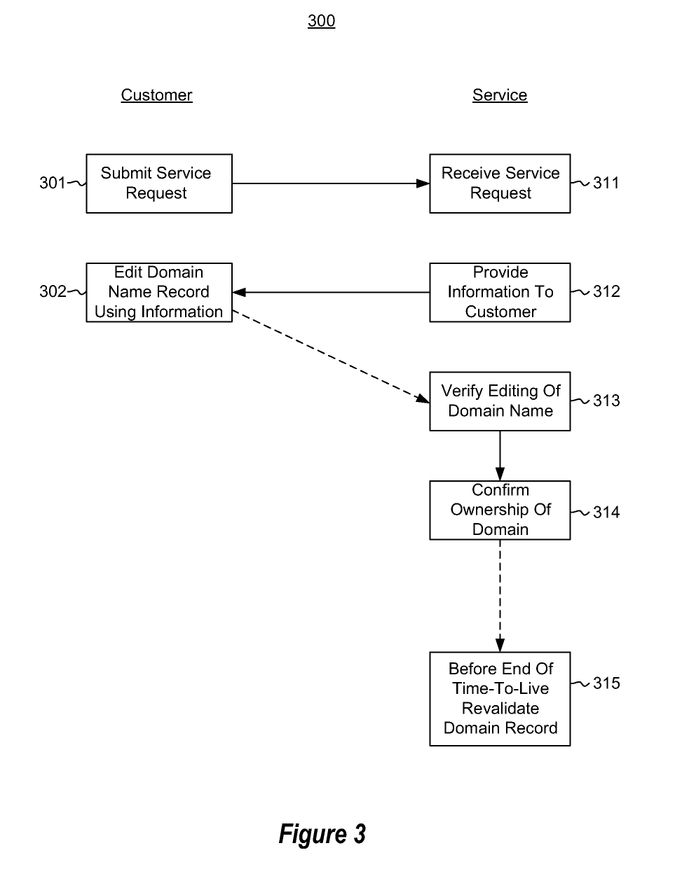

FIG. 3 illustrates a flowchart of a method 300 for a computing system to verify ownership of a particular domain name. When providing services, it is often beneficial to verify that the customer that is requesting the service has ownership over a particular domain. For instance, perhaps the customer is requesting that the service act as an e-mail relay on behalf of a particular domain name that will impersonate users within that domain name. Such would be inappropriate if the customer did not have ownership of that domain name. Some of the acts of the method 300 are performed by a system that verifies ownership of a particular domain name and are listed in the right column of FIG. 3 under the heading “Service”. Others of the acts of the method 300 are performed by the customer, and are listed in the left column of FIG. 3 under the heading “Customer”.

The customer submits a request for a service for action upon a particular domain name (act 301). Herein, “customer” may refer to the person making the request, the entity on behalf of whom the person is making the request, or the computing system used by the person to make the request. The request may be a network request, in which case, the request is transmitted over a network. However, the request may also be made in some other way as well. The requested “action upon a particular domain name” is an action that is appropriate to be performed by an owner of the particular domain name, but generally not by one who is not an owner of the particular domain name. Examples of actions upon a particular domain name might be 1) e-mail management for addresses under the domain name, 2) security management for the domain name, 3) accounts receivable or payable services for purchases made through the domain name, and so forth.

The system receives the request to provide a network service (act 311). For instance, the system may be a computing system that provides the requested service, or may be a computing system that operates to process requests for the service.

At this point, the system may determine that the customer's ownership of the particular domain name is to be verified. For this purpose, the system provides information to the customer over the network (act 312). The system either also provides instructions to the customer to edit a domain name record for the particular domain using the provided information, or the customer understands without such an instruction to edit the domain name record using the provided information. As an example, the provided information may consist of only a globally unique identifier (GUID).

The customer then edits the domain name record using the provided information (act 302). In a specific example, this editing might involve the simple copying of the information directly into the domain name record such that the domain name record includes, perhaps amongst other things, the information provided by the service. For instance, if the information were a GUID, the GUID might just be included in a domain name Resource Record (often abbreviated to “RR”).

Some examples of Resource Records include the following:
A (contains an IPV4 IP address).
AAAA (contains an IPV6 IP address).
CNAME (contains a string representing another domain name—used for aliasing).
NS (contains a string representing another domain name—used to delegate permissions).
MX (contains a string representing another domain name, and a priority number—used for mail routing).
TXT (contains arbitrary text)

A TXT record of the domain name is a good choice for insertion of the GUID since a domain name record may include any number of TXT records for a variety of purposes. Furthermore, systems that rely upon TXT records know how to ignore TXT records that are not purposed by those systems. Thus, the addition of a TXT record with information provided by the system will be ignored by any other systems that rely on TXT records, allowing the domain name record to be edited without interfering with other functionality of the domain name.

The system then verifies that the domain name record has been edited in the expected way using the provided information (act 313). For instance, perhaps a GUID is provided to the customer, and the customer is to include the GUID in the TXT record of the particular DNS domain. The system may then verify that the GUID is, in fact, included within a TXT record of the DNS domain. As an example, the system may periodically make a DNS query to verify whether there is a TXT Resource Record that contains the information expected.

In some embodiments, the domain name owner enters a constant string alongside the GUID. For instance, the TXT record might actually be something like “MicrosoftOnline:523432432432432” rather than just “523432432432432”. The reason why this could be beneficial is two-fold. A first reason is machine readability. When a DNS query is placed for the TXT records for a given domain, there may be more than one result. For instance, the customer may have a TXT record containing their spam filtering information. We can disregard any record that does not begin with the constant string “MicrosoftOnline”. A second reason is human readability. The human readable string makes it somewhat apparent to the actual human that is inserting the record, what the record does. This way, the human will not be tricked into inserting the record and consequently signing up for our services without knowing what they are doing. They will also be less likely to delete the record because they will assume it is required for proper functioning of the service represented by the constant string (in this case, their Microsoft Online Services).

The system then confirms that the customer is an owner of the particular domain (act 314) based on the fact that the domain name record has been edited as expected. In a preferred embodiment, when the system confirms that the customer is an owner of the particular DNS domain, the system defaults to treating the customer as also having permission to act on that DNS domain, as well as all sub-domains under the particular domain. Under this security model, the security of the domain name system DNS is relied upon. It is thus deemed that any entity that is able to edit a domain name record under a particular domain name does indeed have ownership of that domain, since the DNS system would require such ownership prior to allowing the entity to edit that domain name record.

FIG. 3 includes another act 315 that relate to a time-to-live of the edited domain name record, and will be described further below. However, for now, the method 300 of FIG. 3 will be applied to the DNS tree 200 of FIG. 2 using several scenarios.

Suppose that Contoso, Inc. wants to subscribe to an e-mail hosting service to manage all e-mail accounts under the domain “constoso.com” (i.e., domain 221 in FIG. 2). The e-mail service would then endeavor to verify that Contoso, Inc. does indeed own the “contoso.com” domain. The system might then provide some GUID (represented as “y” in FIG. 2) to Contoso, Inc. Contoso, Inc. would then create a TXT record of the “contoso.com” domain in a manner that the GUID “y” is included therein. The e-mail service may then understand from this that Contoso, Inc. does indeed own the contoso.com domain and is thus permitted to act on that domain 221, as well as act on the sub-domains 231 and 232 of “sales.contoso.com” and “research.contoso.com”.

Now suppose that Contoso, Inc. or perhaps its sales department (referred to as the “requesting entity” wants to subscribe to payment service to manage all accounts receivable received under the domain “sales.contoso.com” (i.e., domain 231 in FIG. 2). The payment service would then endeavor to verify that the requesting entity does indeed own the “sales.contoso.com” domain. The system might then provide some GUID (represented as “x” in FIG. 2) to the requesting entity, whereupon the requesting entity would then create a TXT record of the “sales.contoso.com” domain in a manner that the GUID “x” is included therein. The payment service may then understand from this that Contoso, Inc. or its sales entity does indeed own the “sales.contoso.com” domain and is thus permitted to act on that domain 221, as well as act on any sub-domains (not shown in FIG. 2).

It may be perhaps that in addition to editing the domain name record using the information provided from the system, that the customer also inserts a time-to-live for the requesting entity, and that the system enforces the time-to-live. A “time-to-live” is a property of a piece of information that defines a length of time that the information may be taken to be valid. Accordingly, before relying on information with a time-to-live, the time-to-live is verified. If the time-to-live has been exceeded, then systems that enforce the time to live will no longer rely on the associated information.

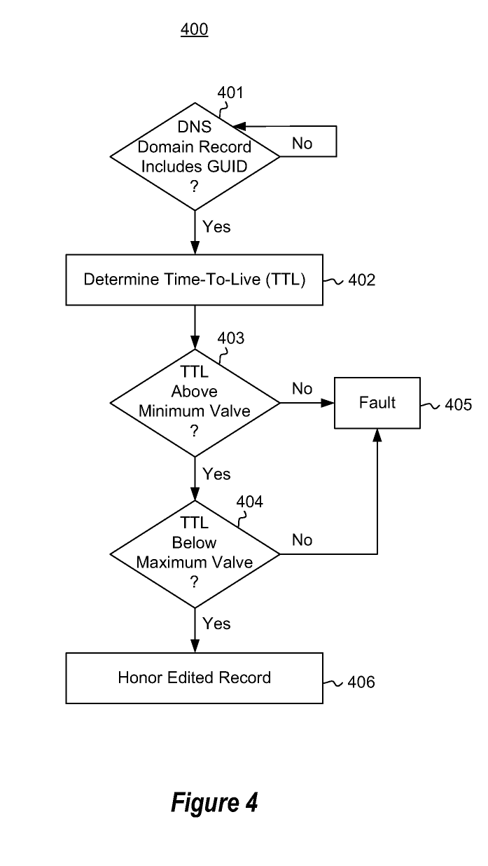

FIG. 4 illustrates a flowchart of a method 400 for verifying that the domain name record has been edited using the information. The method 400 is a specific example of the act 313 of FIG. 3 in the context of the information being a GUID, and in the context of a time-to-live being enforced.

According to method 400, the system determines whether or not the domain name record (a TXT record) of the particular DNS domain includes the GUID (decision block 401). If not (No in decision block 401), then the process perhaps returns to the decision block 401, thereby periodically causing the DNS domain record to be rechecked. The principles described herein are not limited to a particular process for checking or re-rechecking the domain record, and perhaps at some point, the system stops checking and makes no conclusion regarding ownership of the domain.

If the domain record has been edited to include the GUID (Yes, in decision block 401), the system then determines a time-to-live associated with the edited domain name record (act 402). For instance, the time-to-live might have been included by the customer when the domain name record was edited to include the information. Alternatively, the time-to-live might be assumed by the system.

The system then confirms that the time-to-live is above a minimum value (Yes in decision block 403), and that the time-to-live is below a maximum value (Yes in decision block 404). Although the method 400 shows the confirmation of the minimum value (decision block 403) occurring before the confirmation of the maximum value (decision block 404), the ordering of these confirmation is not important.

According to the specific example of FIG. 4, however, the system confirms whether the time-to-live is above a minimum value (decision block 403). When a time-to-live has been expired, the system rechecks the domain name record to verify whether the time-to-live has been updated. If the time-to-live is too short, the burden on the system may be too great with too frequent rechecks to verify the edited information. Thus, a minimum length for the time-to-live may be enforced. Thus, in the case of FIG. 4, if the time-to-live is not above a minimum value (No in decision block 403), then a fault has occurred (act 405), and the customer is prompted to reedit the domain name record with a longer time-to-live.

If the time-to-live is above the minimum value (Yes in decision block 403), then perhaps the time-to-live is checked against a maximum value as well (decision block 404). In some case, it may be beneficial to ensure that the time-to-live is not too long. After all, domains can transfer ownership, and a time-to-live that is too long might cause the service to continue to provide a service for the particular domain to a prior owner of the domain name even though ownership is transferred. Thus, a maximum length for the time-to-live may be enforced. Thus, in the case of FIG. 4, if the time-to-live is not below a maximum value (No in decision block 404), then a fault has occurred (act 405), and the customer is prompted to reedit the domain name record with a shorter time-to-live.

If the time-to-live is below the maximum value (Yes in decision block 404), then the edited domain record will be honored (act 406), meaning that the customer will be deemed to be owner of the particular domain.

Returning to FIG. 3, in the case in which there are time-to-lives, before the end of the time-to-live, the service will verify that the domain name record remains edited using the provided information (act 315). If this re-verification results in a determination that the domain name record does not remain edited using the information, the system determines that the customer no longer has ownership of the particular domain name. On the other hand, if the re-verification results in a determination that the domain name record does remain edited using the information, the system determines that the customer continues to have ownership of the particular domain name.

Accordingly, the principles described herein permit for more complete and secure verification of ownership of a domain name. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for a computing system to verify ownership of a particular domain name, the method comprising:
an act of the computing system receiving a network request to provide a network service to a customer for action upon a particular domain name;
an act of the computing system providing information to the customer over a network, and instructing the customer to edit a domain name record for the particular domain using the provided information;
an act of the computing system verifying that the domain name record has been edited using the provided information; and
an act of the computing system confirming that the customer is an owner of the particular domain in response to the act of verifying.

2. The method in accordance with claim 1, wherein the act of the computing system verifying that the domain name record has been edit using the provided information also comprises:
an act of determining a time-to-live associated with the edited domain name record.

3. The method in accordance with claim 2, wherein the act of the computing system verifying that the domain name record has been edited using the provided information comprises:
an act of confirming that the time-to-live is above a minimum value.

4. The method in accordance with claim 2, wherein the act of the computing system verifying that the domain name record has been edited using the provided information comprises:
an act of confirming that the time-to-live is below a maximum value.

5. The method in accordance with claim 2, further comprising:
before the end of the time-to-live, an act of attempting to verify that the domain name record remains edited using the provided information.

6. The method in accordance with claim 5, wherein if the act of attempting to verify results in a determination that the domain name record does not remain edited using the information, the method further comprises:
an act of determining that the customer no longer has ownership of the particular domain name.

7. The method in accordance with claim 5, wherein if the act of attempting to verify results in a determination that the domain name record does remain edited using the information, the method further comprises:
an act of determining that the customer continues to have ownership of the particular domain name.

8. The method in accordance with claim 1, wherein the act of the computing system confirming that the customer is an owner of the particular domain further comprises:
an act of the computing system confirming that the customer is an owner of the particular domain and all sub-domains under the particular domain.

9. The method in accordance with claim 1, wherein the act of the computing system verifying that the domain name record has been edited using the provided information comprises:
an act of verifying that the domain name record includes the provided information.

10. The method in accordance with claim 1, wherein the domain name record is a TXT record of the particular domain name.

11. A computer program product comprising one or more computer-storage media having thereon computer-executable instructions that are structured to be executed by one or more processors of a computing system in response to the computing system receiving a request to provide a network service to a customer for action upon a particular domain name, the computer-executable instructions being further structured such that, when executed by the one or more processors, the computing system is caused to perform the following:
an act of providing information to the customer over a network, and instructing the customer to edit a domain name record for the particular domain using the provided information;
an act of the verifying that the domain name record has been edited using the provided information; and
an act of the confirming that the customer is an owner of the particular domain in response to the act of verifying.

12. The computer program product in accordance with claim 11, wherein the act of the verifying that the domain name record has been edited using the provided information also comprises:
an act of determining a time-to-live associated with the edited domain name record.

13. The computer program product in accordance with claim 12, wherein the act of verifying that the domain name record has been edited using the provided information comprises:
an act of confirming that the time-to-live is above a minimum value.

14. The computer program product in accordance with claim 12, wherein the act of verifying that the domain name record has been edited using the provided information comprises:
an act of confirming that the time-to-live is below a maximum value.

15. The computer program product in accordance with claim 12, wherein the computer-executable instructions are further structured such that, when executed by the one or more processors, the computer further performs the following:
before the end of the time-to-live, an act of attempting to verify that the domain name record remains edited using the provided information.

16. The computer program product in accordance with claim 15, wherein if the act of attempting to verify results in a determination that the domain name record does not remain edited using the information, the computer-executable instructions are further structured to cause the computing system to perform the following:
an act of determining that the customer no longer has ownership of the particular domain name.

17. The computer program product in accordance with claim 15, wherein if the act of attempting to verify results in a determination that the domain name record does remain edited using the information, the computer-executable instructions are further structured to cause the computing system to perform the following:
an act of determining that the customer continues to have ownership of the particular domain name.

18. The computer program product in accordance with claim 11, wherein the act of the computing system confirming that the customer is an owner of the particular domain further comprises:
an act of the computing system confirming that the customer is an owner of the particular domain and all sub-domains under the particular domain.

19. The computer program product in accordance with claim 11, wherein the act of the computing system verifying that the domain name record has been edited using the provided information comprises:
an act of verifying that the domain name record includes the provided information.

20. A computer program product comprising one or more computer-storage media having thereon computer-executable instructions that are structured to be executed by one or more processors of a computing system in response to the computing system receiving a request to provide a network service to a customer for action upon a particular domain name, the computer-executable instructions being further structured such that, when executed by the one or more processors, the computing system is caused to perform the following:
an act of providing information to the customer over a network, and instructing the customer to edit a domain name record for the particular domain using the provided information;
an act of the verifying that the domain name record has been edited using the provided information;
an act of determining a time-to-live associated with the edited domain name record;
an act of determining that the time-to-live associated with the edited domain name is above a minimum threshold;
an act of the confirming that the customer is an owner of the particular domain in response to the act of verifying; and
before the end of the time-to-live, an act of attempting to verify that the domain name record remains edited using the provided information, wherein if the act of attempting to verify results in a determination that the domain name record does not remain edited using the information, the customer is determined to no longer have ownership of the particular domain name, wherein if the act of attempting to verify results in a determination that the domain name record does remain edited using the information, the customer is determined to continue to have ownership of the particular domain name.
